(19) United States
(12) Patent Application Publication
(10) Pub. No.: US 2026/0039112 A1
(43) Pub. Date: Feb. 5, 2026

(54) SYSTEMS AND METHODS TO MITIGATE SUBSYNCHRONOUS OSCILLATION IN SERIES COMPENSATED TRANSMISSION GRID

(71) Applicant: The Board of Trustees of The University of Alabama, Tuscaloosa, AL (US)

(72) Inventor: Shuhui Li, Tuscaloosa, AL (US)

(21) Appl. No.: 19/284,269

(22) Filed: Jul. 29, 2025

Related U.S. Application Data
(60) Provisional application No. 63/678,582, filed on Aug. 2, 2024.

(51) Int. Cl. H02J 3/24; H02J 3/01; H02J 3/38

(52) U.S. Cl. CPC H02J 3/241; H02J 3/01; H02J 3/38

(57) ABSTRACT

Systems and method to minimize conditions that cause sub-synchronous oscillation (SSOs) associated with series compensated transmission grids. The implementations ensures the correct development of methods and systems that can mitigate sub-synchronous oscillation (SSOs) associated with a series compensated transmission grid and enhance the series compensation efficiency. An example implementation is a network-based SSO mitigation technology, and another example implementation is a generator-based SSO mitigation technology. The discovery and example implementations are applicable to series compensated transmission networks with synchronous generators, induction generators, wind turbines, solar photovoltaic generators, charging stations, battery storage systems, high-voltage DC transmission systems, STATCOMs, inverter-based data centers, and other inverter-based resources.

### CROSS-REFERENCE TO RELATED APPLICATIONS

This application claims the benefit of U.S. Provisional Patent Application No. 63/678,582, filed on Aug. 2, 2024, the entire contents of which are incorporated herein by reference.

### BACKGROUND

The present disclosure relates generally to the field of electrical grids, and more specifically to systems and methods to mitigate sub-synchronous oscillation in a series compensated transmission grid.

### SUMMARY

In some aspects, the techniques described herein relate to an apparatus for mitigating sub-synchronous oscillation (SSO) in a transmission line having a series capacitor compensations system, including: a passive component connected in parallel with the series capacitor compensation system on the transmission line, wherein the passive component is configured to pass low-order harmonic currents.

In some aspects, the techniques described herein relate to an apparatus, wherein the passive component includes at least one of (i) a resistor, (ii) an inductor, or (iii) a series combination of the resistor and the inductor.

In some aspects, the techniques described herein relate to an apparatus, wherein the passive component includes the series combination of the resistor and the inductor.

In some aspects, the techniques described herein relate to an apparatus, wherein the transmission line is part of a grid, wherein the grid is an interconnected network for electricity delivery from producers to consumers.

In some aspects, the techniques described herein relate to an apparatus, wherein the resistor does not affect an efficiency of the series compensation capacitor at a fundamental frequency of the grid.

In some aspects, the techniques described herein relate to an apparatus, wherein the resistor does not increase a resultant line resistance or resistive loss at a fundamental frequency of the grid.

In some aspects, the techniques described herein relate to an apparatus, wherein the resistor does not increase a resultant line impedance below a fundamental frequency of the grid and allows low-order harmonic current to pass through the resistor, and wherein the series compensation capacitor blocks the low-order harmonic current.

In some aspects, the techniques described herein relate to an apparatus, further connected to an electric generator.

In some aspects, the techniques described herein relate to an apparatus, wherein the passive component reduces an increase in low-order bus voltage distortion in the transmission line.

In some aspects, the techniques described herein relate to a method of mitigating sub-synchronous oscillation (SSO) in a transmission line having a series capacitor compensation system, including: coupling, to the transmission line and in parallel with the series capacitor compensation system, a series combination of a resistor and an inductor.

In some aspects, the techniques described herein relate to a method, wherein the series combination of the resistor and the inductor reduce an increase in low-order bus voltage distortion in the transmission line.

In some aspects, the techniques described herein relate to a method, further including determining an inductance of the inductor and a resistance of the resistor that together allow low-order harmonic current to pass through the resistor.

In some aspects, the techniques described herein relate to a method, wherein the transmission line is connected to a grid, and wherein determining the inductance and the resistance includes determining the inductance and the resistance based on a capacitance of the series capacitor compensation system and one or more parameters of the grid.

In some aspects, the techniques described herein relate to an electric generator system, including: an electric generator; a generator controller, wherein the electric generator is electrically connected to the generator controller via an electrical conductor; a signal conditioning system disposed on the electrical conductor and configured to filter signals traveling from the electrical generator to the generator controller.

In some aspects, the techniques described herein relate to an electrical generator system, wherein the signal conditioning system includes at least one of (i) a band-pass filter, (ii) a low-pass filter, (iii) a high-pass filter, or (iv) a compensation circuit.

In some aspects, the techniques described herein relate to an electrical generator system, wherein the signal conditioning system prevents high-frequency noise and harmonic distortion originating from a transmission grid from being amplified within the electric generator.

In some aspects, the techniques described herein relate to an electric generator system, wherein the signal conditioning system prevents sub-synchronous-frequency distortion originating from a transmission grid from being amplified within the electric generator.

In some aspects, the techniques described herein relate to an electric generator system, wherein the signal conditioning system maintains a frequency of measured signals at a fundamental frequency of a grid, wherein the grid is an interconnected network for electricity delivery from producers to consumers.

In some aspects, the techniques described herein relate to an electric generator system, further including a sensor, and wherein the signal conditioning system is applied after the sensor to prevent low-order harmonics and high-order harmonics from entering the generator controller, and wherein the signal conditioning system has a low cut-off frequency below a fundamental frequency of a grid that the electrical generator system is connected to and a high cut-off frequency above a fundamental frequency of a grid.

In some aspects, the techniques described herein relate to an electric generator system, wherein the low cut-off frequency is 30 Hz and the high cut-off frequency is above 2000 Hz.

### BRIEF DESCRIPTION OF THE DRAWINGS

The above and other aspects and features of the present disclosure will become more apparent to those skilled in the art from the following detailed description of the example embodiments with reference to the accompanying drawings.

FIG. 1 illustrates an example series compensated power transmission corridor.

FIG. 2 illustrates an example of fixed series compensation (FSC).

FIG. 3 illustrates an example of the thyristor-controlled series compensation (TCSC).

FIG. 4 illustrates an example of a full-scale Inverter-Based clean energy Resource (IBR) system.

FIG. 5 illustrates an example connection diagram of a grid connected wind power plant (WPP).

FIG. 6 illustrates an example control structure of a full-scale inverter interfaced IBR plant: plant level control and IBR level control.

FIG. 7 illustrates an example passive filter in parallel with series capacitor.

FIG. 8 illustrates an example interconnection of wind turbine or wind power plant with the series compensated power transmission grid.

FIG. 9 illustrates an example of mitigating SSR/SSO by applying a parallel resistor with the series compensation capacitor in accordance with aspects of the disclosure.

FIG. 10 illustrates an example of mitigating SSR/SSO by applying a parallel inductor (in series with a small resistor) with the series compensation capacitor in accordance with aspects of the disclosure.

FIG. 11 illustrates an example of connecting an IBR plant to the grid through a series compensated transmission line with an inductor connected in parallel with the series capacitor in accordance with aspects of the disclosure.

FIG. 12 shows a comparison of the transmission line impedance amplitude vs the frequency without the series compensated capacitor, with the series capacitor, and with both the series capacitor in accordance with aspects of the present disclosure.

FIGS. 13A-13J shows EMT simulation results of the IBR plant connected to the grid via the series compensated line without and with aspects of the present disclosure.

FIG. 14A illustrates a low pass filter used within an IBR.

FIG. 14B illustrates a band pass filter used within an IBR.

FIG. 14C illustrates a low high pass filter used within an IBR.

FIGS. 15A-15J illustrates an example simulation of an IBR plant connected to the grid via series compensation capacitor with and without aspects of the disclosure applied to IBRs.

FIG. 16 illustrates an example of a passive element in parallel with a series compensation capacitor.

FIGS. 17A-17C illustrate frequency characteristics of a series compensated transmission line, according to several example embodiments.

FIG. 18 illustrates an example of generator-based SSO mitigation.

FIGS. 19A-19B illustrates example series-connected devices.

FIG. 20 illustrates frequency characteristics of a series-connected device, according to an exemplary embodiment.

FIGS. 21A-21B include a system diagram and a control diagram for an example static synchronous compensator.

FIG. 22 illustrates a generator system with controllers that may be connected to a grid, according to an example.

FIG. 23 illustrates an SSO mitigation device for a generator, according to an exemplary embodiment.

### DETAILED DESCRIPTION

Referring generally to the FIGURES, described herein are systems and methods to mitigate subsynchronous oscillation in a series compensated transmission grid.

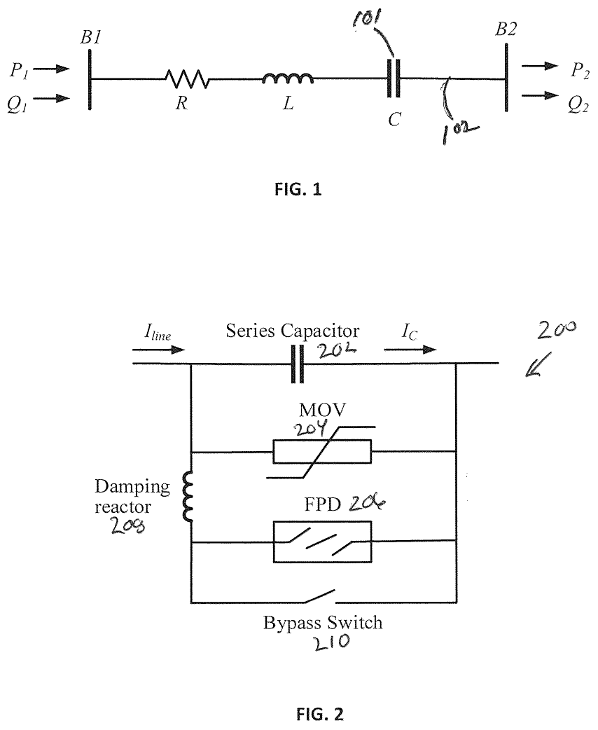

Turning to FIG. 1, a series compensation system is shown, according to an exemplary embodiment. The series compensation system may be designed to improve the efficiency and stability of electrical transmission networks by counteracting inductive reactance and voltage drop associated with long-distance power transmission. The series compensation system includes a capacitor bank (shown as capacitor 101). The capacitor bank is connected in series along transmission line 102 to counteract inductive reactance and improve the power factor of the system (e.g., thereby increasing power transfer capability and improving voltage stability).

The series compensation system may provide one or more benefits such as (i) voltage stability improvement (e.g., the series compensation systems may play a crucial role in maintaining voltage stability, especially in long-distance transmission lines, by mitigating voltage drops and reactive power losses, etc.), (ii) increased power transfer capability (e.g., the use of series capacitors may enhance the power transfer capability of transmission lines, allowing for more efficient use of existing infrastructure and reducing the need for new investments in transmission capacity, etc.), (iii) grid reliability and power quality (e.g., series compensation systems contribute to the overall reliability of the electrical grid by reducing transmission line losses and improving power quality and mitigating voltage sags and enhancing the resilience of the grid against disturbances, etc.), (iv) renewable energy integration (e.g., series compensation systems may facilitate accommodating the variable nature of renewable energy generation and optimizing power flow, etc.).

In some contexts, series capacitors create sub-synchronous resonance (SSR) or sub-synchronous oscillation (SSO). In SSO, the capacitor bank's electrical characteristics create a resonance with harmonic frequencies in the transmission system and/or generators that can result in damage to the grid and generators. Accordingly, there is a need for improvements to series compensation systems to reduce the negative effects associated with SSR/SSO.

Series compensation systems may include fixed series compensation (FSC) and thyristor-control series compensation (TCSC).

Referring to FIG. 2, FSC installation 200 is shown, according to an exemplary embodiment. FSC installation 200 includes a parallel combination of capacitors 202 (e.g., a capacitor bank), over-voltage protection (shown as metal oxide varistor (MOV) 204 and fast protective device (FPD) 206), and a bypass breaker 210. Capacitors 202 may be rated to line currents associated with normal peak power flow. The relation of the series capacitor reactance X_{C}=1/(ω·C) and the inductive reactance X_{L}=ω·L of the compensated transmission line may be given according to:

$${X}_{C} = k \cdot {X}_{L} \qquad ( 1 )$$

where ω=2πf in which f is the frequency of the grid, and k represents the degree of compensation. In various embodiments, the degree of compensation is within the range 0.3≤k≤0.7.

In various embodiments, over voltage protection 204/206 limits the voltage across capacitors 202 during fault conditions. Over voltage protection 204/206 may include MOV 204 and FPD 206. MOV 204 may conduct negligible current during normal operation and may conduct freely once the voltage across it reaches the protection level (e.g., thereby bypassing capacitors 202). MOV 204 may be the primary device that protects capacitors 202 from overvoltage by diverting fault current. MOV 204 may be and/or include semiconductors with highly non-linear characteristics that conduct above a specific voltage (e.g., a protective level voltage). MOV 204 may limit the voltage across capacitors 202 to a safe value for capacitors 202. MOV 204 may handle very high current for short periods of time and protect capacitors 202 until another bypass path is established. If the fault is cleared before reaching the ratings of MOV 204, MOV 204 may stop conducting once the voltage across it drops below the protection level and capacitors 202 will return to normal operating conditions.

FPD 206 can be triggered for certain fault conditions such as faults on compensated line segments or for extreme faults when the energy absorbed by MOV 204 exceeds rated values. FPD 206 may be and/or include triggered air gaps and/or arc-plasma injectors in parallel with a fast contact (e.g., to avoid the difficulty of correctly distancing and maintaining the electrodes in the air gap).

Bypass breaker 210 (shown as bypass switch) may be in an open position during normal operation and may switch capacitors 202 in/out during planned operations. Bypass breaker 210 may bypass capacitors 202, MOV 204, and FPD 206 if the fault is not cleared within a pre-determined time. Bypass breaker 210 may be able to carry the rated MOV voltage as well as the maximum capacitor discharge current. Bypass breaker 210 may be rated to withstand the higher transient frequency and interrupting currents when bypassing capacitors 202.

In some embodiments, FSC installation 200 includes damping circuit 208 (e.g., an air core reactor, etc.) in series with FPD 206 and bypass breaker 210 to limit and dampen capacitor discharge currents when FPD 206 triggers or bypass breaker 210 is closed.

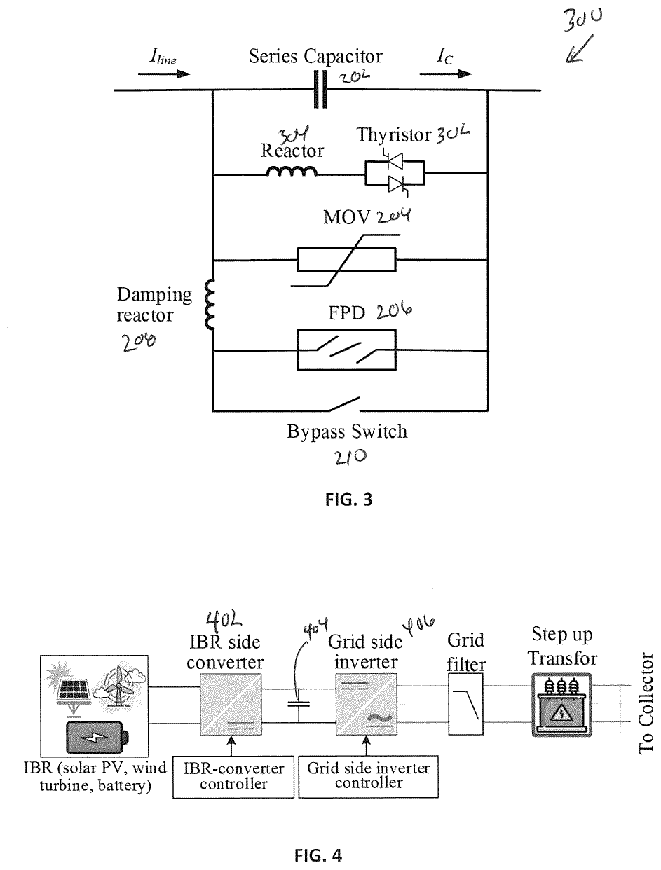

Turning now to FIG. 3, a thyristor-controlled series compensation (TCSC) installation (shown as installation 300) is shown, according to an exemplary embodiment. Installation 300 may include two modules connected in series: (i) a fixed series compensation module (as described above with reference to FIG. 2) and (ii) a module including capacitors 202 in parallel with a thyristor controlled (shown as thyristor 302) air core reactor 304.

When thyristor 302 gate is blocked, full current may flow through the capacitance and the line is fully compensated. When thyristor 302 gate is fully conducting, the capacitor may be effectively bypassed. If the valves are gated for partial conductance, it is possible to smoothly vary the impedance of installation 300. Over-voltage protection may be assured by the connection of MOV 204 across capacitors 202. Bypass breaker 210 (or a disconnect) may be included to allow for maintenance and better over-voltage protection.

Installation 300 may be 100% variable. Alternatively, installation 300 may have a fixed level of compensation combined with a variable level of compensation (e.g., thereby allowing cost to be optimized by only controlling the series capacitance that provides reliability or other benefits).

Referring now to FIG. 4, inverter-based resources (IBRs) are shown, according to an exemplary embodiment. IBRs may include solar PV generators, WTs (i.e. Type-3 and Type-4 WTs), and/or energy storage systems. In various embodiments, IBRs (except for the Type-3 WT) are connected to the grid through a full-size DC/AC inverter. The DC/AC inverter may include converter 402 at the IBR-side, capacitor 404 at the DC-link, and converter 406 at the grid-side. Converter 402 may control the energy extraction from solar or wind or energy management of an energy storage system. In various embodiments, converter 402 is an AC/DC type for a Type-4 WT and a DC/DC type for a solar PV and energy storage system. Converter 406 may regulate reactive power flow at the point of connection (POC) and may maintain a fixed DC-link voltage. In various embodiments, converter 406 is a DC/AC type. In various embodiments, an IBR plant includes a group of IBRs in the same location that are connected together to produce electricity.

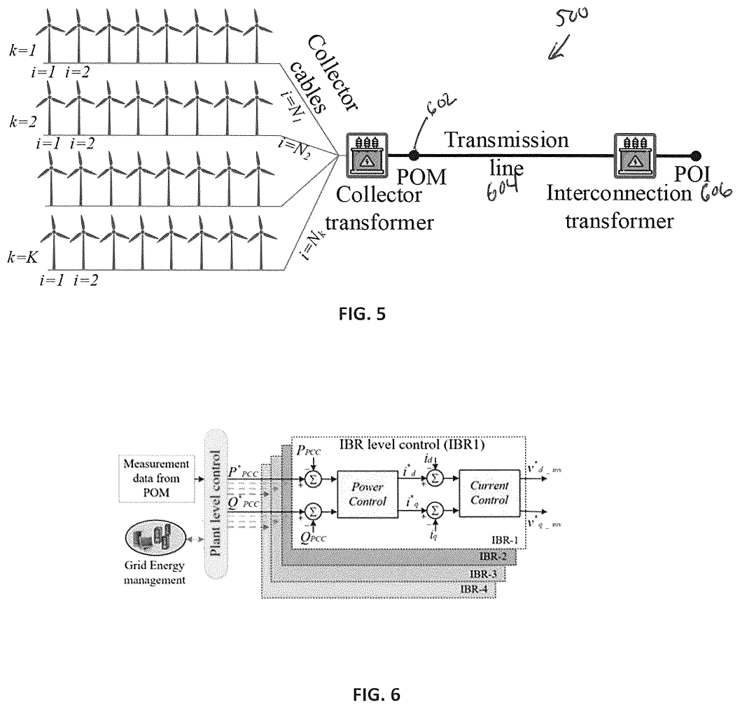

Referring to FIG. 5, a connection diagram of a grid-connected onshore WPP 500 is shown, according to an exemplary embodiment. As shown, k represents the parallel feeder index and i represents the index of a series path in each parallel feeder. In various embodiments, the output voltage of each WT generator is 690V and all the WTs within WPP 500 are connected to a medium-voltage (MV) substation (e.g., 25 kV/120 kV) via a collector system. Connection point 602 (e.g., the point of measurement (POM)) may be connected to the bulk power system (BPS) via transmission line 604 that can be up to several hundred miles long. The connection point 606 is called point of interconnection (POI).

In some embodiments, a utility-scale SPP may include hundreds to thousands of strings of PV panels. A string-inverter may connect each string with the collector system. The collector system is connected to the POM via a step-up transformer. A transmission line may connect the SPP with the POI via an interconnection transformer.

Referring now to FIG. 6, an IBR control system is shown, according to an exemplary embodiment. From the grid interconnection point of view, an IBR within an IBR plant can be assumed to have a constant DC-link voltage with a controller for the grid-side inverter. The controller of the grid-side inverter may have a cascaded inner current control loop and an outer active and/or reactive power control loop. The control loops may be designed in the dq reference frame. The power reference signals (P*_{POC} and Q*_{POC}) may be generated based on grid requirements (either at the POM or POI) and sent to the outer-loop controller of each individual IBR. The outer control loop may produce d- and q-axis current reference signals and send them to the inner control loop. The inner control loop may produce d- and q-axis controlled output voltages, denoted as v*_{d_inv} and v*_{q_inv}. The controlled voltages may be injected to the power grid. The relation between the inverter end voltage (v_{dq_inv}) and the controller output voltage (v*_{dq_inv}) can be written as follows,

$${v}_{dq \_ inv} = {k}_{PWM} \cdot {v}_{dq \_ inv}^{*} \qquad ( 2 )$$

where k_{PWM} is the ratio of the inverter end voltage to the controller output voltage caused by the pulse width modulation (PWM) process.

In various embodiments, IBR grid-connected inverters can operate in linear and overmodulation regions. In normal conditions, IBR inverters may operate in the inverter linear modulation region. In the linear modulation region, the current from an IBR is approximately sinusoidal and the high-order harmonics may be blocked or filtered by the IBR grid-connected filters and inductance of transmission lines. Additionally or alternatively, IBR inverters may operate close or beyond the PWM saturation limit of the IBR converters (e.g., depending on the real-time IBR and grid operating conditions), thereby causing more harmonics (e.g., high order and/or low order harmonics) to be generated and injected into the grid.

In various embodiments, sub-synchronous interaction (SSI) phenomenon occurs when two power system elements exchange energy below the synchronous frequency. SSI can lead to SSO and may cause outages and/or damage to network equipment. SSI may include SSR, SSCI, and/or SSTI. The most prominent forms of SSI can be classified into SSR, sub-synchronous control interaction (SSCI), and sub-synchronous torsional interaction (SSTI).

In SSR, an electric power system (e.g., a power system with series compensated transmission lines, etc.) exchanges energy with a turbo-generator at one or more of the natural frequencies below the fundamental frequency of the power system. SSR may include three types: (i) Torsional Interaction (SSR TI), (ii) Induction Generator Effect (IGE), and (iii) Torque Amplification (SSR TA).

In SSCI, a power electronic device (e.g., HVDC, SVC, STATCOM, IBRs, etc.) interacts at a natural frequency with the electric power network including near-by series compensated transmission. SSCI may increase due to fast converter control in a pure electrical network.

In SSTI, a power electronic device (e.g., HVDC link, SVC, IBRs, etc.) interacts with the mechanical mass system of a turbo-generator.

Systems and methods of the present disclosure may provide one or more benefits/improvements such as (i) maintaining series compensation efficiency, (ii) reducing a need for high rated elements (e.g., due to short circuit exposure), thereby reducing a cost of mitigation, and/or (iii) reducing complexity by reducing a need for component ratings, de-tuning impacts, and maintenance optimizations, thereby reducing a cost of mitigation.

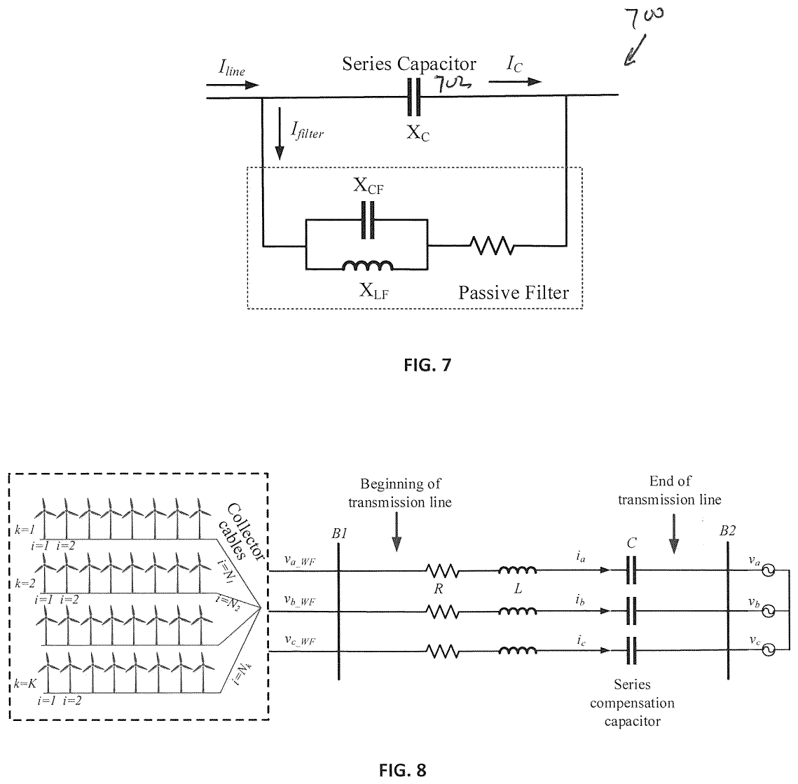

The interconnection of IBRs or IBR plants with the transmission grid through a series capacitor compensation system can be illustrated by a wind power plant connected to the grid shown in FIG. 8, in which the grid voltage on the right is mostly sinusoidal and the IBRs or IBR plants on the left typically contribute harmonics due to the switching impacts of IBR inverters as described above. To develop an appropriate technique to mitigate the SSO impact for IBRs connected to a series-compensated transmission grid, it is important to investigate how harmonics from the IBR inverters interact with the series capacitor compensated systems. Although FIG. 8 gives a simplified illustration of a wind power plant and grid integration configuration with series compensation systems, this illustration is more convenient to guide to an effective understanding of the true impacts of series capacitors on the integrated electric power generation (including synchronous generators, wind turbines, solar photovoltaic generators, charging stations, etc.) and transmission grid (including HVDC, STATCOMs, data centers, etc.). FIG. 7 illustrates system 700 including an example passive filter in parallel with capacitor 702.

Referring now to FIG. 8, a wind power plant connected to a grid is shown, according to an exemplary embodiment. As shown, v_{a,b,c_WF} represents the wind power plant voltage at Bus B1 (POM bus) in the three-phase frame, v_{a,b,c} represents the grid voltage at Bus B2 (POI bus), and i_{a,b,c} represents the current flowing through the series compensated transmission line between Bus B1 and Bus B2. The voltage balance equation across the series compensated transmission line may be given by:

$$[ {v}_{a , b , c \_ WF} ] = R [ {i}_{a , b , c} ] + L \frac{d}{d t} [ {i}_{a , b , c} ] + \frac{1}{C} \cdot \int [ {i}_{a , b , c} ] d t + [ {v}_{a , b , c} ] \qquad ( 3 )$$

The POM voltage at Bus B1 in Eq. (3) may affect the voltage at the wind turbine terminal. In various embodiments, when more power is generated from the WPP and transmitted to the grid through the transmission line (including connecting more wind turbines to the POM), the POM voltage at Bus B1 will be higher. In various embodiments, when the POM voltage increases, the wind turbine terminal voltage increases as well. In various embodiments, when the wind turbine terminal voltage increases, the wind turbine converters may operate closer (or beyond) the PWM saturation limit of the wind turbine converters (e.g., thereby injecting more harmonics from the wind farms to the grid through the series compensated transmission line). These may include both high-order harmonics over the grid fundamental frequency (super-synchronous) and low-order harmonics below the grid fundamental frequency (sub-synchronous). When more harmonics are generated from wind turbines and pass through the transmission line, the POM voltage may become more distorted (e.g., thereby causing the wind turbine terminal voltage to become more distorted too).

The distortion of the wind turbine terminal voltage may affect the wind turbine converter controllers (e.g., impacting the phase-locked loop (PLL) and controllers of the wind turbine converters, etc.). Oscillations of the wind turbine controllers and wind turbines may be caused by the distortions and may become worse.

Still referring to FIG. 8, the steady-state voltage balance equation across the series compensated transmission line in the phasor domain may be given by:

$${V}_{WF} = R \cdot {I}_{Line} + {jI}_{Line} \cdot {X}_{L} - {jI}_{Line} \cdot {X}_{C} + {V}_{Grid} \qquad ( 4 )$$

where V_{WF} represents the steady-state phasor voltage of the WPP at Bus B1 (POM bus), V_{Grid} is the steady-state phasor voltage of the grid at Bus B2, and I_{Line} is the steady-state phasor current flowing through the series compensated transmission line between Bus B1 and Bus B2. Eq. (4) may include equations corresponding to the fundamental frequency and low and high order harmonics. As an example, if the grid voltage is sinusoidal and the harmonics come from the WPP, then the voltage balance equation at the fundamental frequency may be:

$${V}_{WF}^{1} = R \cdot {I}_{Line}^{1} + j {I}_{Line}^{1} \cdot {X}_{L}^{1} - j {I}_{Line}^{1} \cdot {X}_{C}^{1} + {V}_{Grid} \qquad ( 5 )$$

where the fundamental frequency is f₁=60 Hz in the United States and the fundamental angular frequency is ω1=2π×f₁,

$${X}_{L}^{1} = {ω}_{1} L , {X}_{C}^{1} = 1 / ( {ω}_{1} C ) , {V}_{WF}^{1}$$

represents the fundamental steady-state phasor voltage at Bus B1 (POM bus), and

$${I}_{Line}^{1}$$

is the fundamental stead-state phasor current flowing through the series compensated transmission line between Bus B1 and Bus B2. The steady-state voltage balance equation at a harmonic frequency may be:

$${V}_{W F}^{n} = R \cdot {I}_{Line}^{n} + j {I}_{Line}^{n} \cdot {X}_{L}^{n} - j {I}_{Line}^{n} \cdot {X}_{c}^{n} \qquad ( 6 )$$

where the frequency of the n^{th} order harmonic is fₙ=n×60 Hz and the angular frequency of the n^{th} order harmonic is

$$ω n = 2 π \times {f}_{n} , {X}_{L}^{n} = {ω}_{n} L , {X}_{C}^{n} = 1 / ( {ω}_{n} C ) , {V}_{WF}^{n}$$

represents the steady-state phasor voltage of the n^{th} order harmonic at Bus B1 (POM bus), and

$${I}_{Line}^{n}$$

is the steady-state phasor current of the n^{th} order harmonic flowing through the series compensated transmission line between Bus B1 and Bus B2.

Based on the above equations, the following examples are presented:

### Example 1: No Series Capacitor Added in the Transmission Line

When there is no series capacitor in the transmission line, Eqs. (5) and (6) are as follows:

$${V}_{WF}^{1} = R \cdot {I}_{Line}^{1} + {jI}_{Line}^{1} \cdot ( 2 π {f}_{1} \cdot L ) + {V}_{Grid} \qquad ( 7 )$$

$${V}_{WF}^{n} = R \cdot {I}_{Line}^{n} + {jI}_{Line}^{n} \cdot ( 2 π {f}_{n} \cdot L ) \qquad ( 8 )$$

When wind turbine converters operate in the linear modulation region, the currents from the wind turbines are mainly sinusoidal, meaning

$${I}_{Line}^{n} = 0$$

and thus

$${V}_{WF}^{n} = 0$$

according to Eq. (8). Hence, the POM voltage V_{WF} at Bus B1 is mainly sinusoidal and the POC (point of connection) voltage at the wind turbine terminal is primarily sinusoidal too. Under such a high-quality POC voltage, the wind turbine converter controllers can provide the best performance to achieve the maximum wind power extraction and grid integration control of the wind turbine.

When wind turbine converters operate closer to or beyond the over modulation region or PWM saturation constraint, the wind turbines may inject fundamental frequency current and harmonic currents. The closer the wind turbine converters operate to the converter PWM saturation constraint, the more low- and high-order harmonics may be injected by the wind turbines to the grid through the transmission line. The low-order harmonic currents can easily pass through the transmission line inductance while the high-order harmonic currents will be constrained or blocked by the line inductance. The harmonic current through the transmission line will increase the distortion of the POM voltage according to Eq. (8) and the distortion of the POC voltage at the wind turbine terminal as well. The higher the harmonic frequency, the higher distortion the POM harmonic voltage

$${V}_{WF}^{n} .$$

When fₙ→∞ then

$${V}_{WF}^{n} \to ∞ .$$

As the harmonic frequency increases, the harmonic currents of the wind turbines drop quickly. On the other hand, the impact of the low-order or sub-synchronous harmonics is relevantly insignificant according to Eq. (8). Under such a distorted POC voltage, the wind turbine converter controllers and PLLs will be affected.

### Example 2: Transmission Line with Series Compensation Capacitor

When the series capacitor is added in the transmission line, Eqs. (5) and (6) can be further written as follows:

$${V}_{WF}^{1} = R \cdot {I}_{Line}^{1} + {jI}_{Line}^{1} \cdot ( 2 π {f}_{1} \cdot L ) - {jI}_{Line}^{1} \cdot \frac{1}{2 π {f}_{1} \cdot C} + {V}_{Grid} \qquad ( 9 )$$

$${V}_{WF}^{n} = R \cdot {I}_{Line}^{n} + {jI}_{Line}^{n} \cdot ( 2 π {f}_{n} \cdot L ) - {jI}_{Line}^{n} \cdot \frac{1}{2 π {f}_{n} \cdot C} \qquad ( 10 )$$

When wind turbine converters operate in the linear modulation region, the currents from the wind turbines are mainly sinusoidal, meaning

$${I}_{Line}^{n} = 0$$

and thus

$${V}_{WF}^{n} = 0$$

according to Eq. (10). Hence, the POM voltage V_{WF} at Bus B1 is mainly sinusoidal and the POC voltage at the wind turbine terminal is primarily sinusoidal too. Under such a high-quality POC voltage, the wind turbine converter controllers can provide the best performance to achieve the wind power extraction and grid integration control of the wind turbine.

However, when wind turbine converters operate closer to (or beyond) the over modulation region or PWM saturation constraint, the wind turbines will inject fundamental frequency current and harmonic currents. The closer the wind turbine converters are to the converter PWM saturation constraint, the more low- and high-order harmonics will be injected by the wind turbines to the grid through the transmission line. The harmonic current through the transmission line will increase the distortion of the POM voltage according to Eq. (10) and the distortion of the POC voltage at the wind turbine terminal.

For the line inductance, the higher the harmonic frequency, the higher the POM harmonic voltage

$${V}_{WF}^{n} .$$

When fₙ→∞ then

$${V}_{WF}^{n} \to ∞ .$$

On the other hand, the impact of the low-order or sub-synchronous harmonics is relevantly insignificant according to Eq. (10). For the series capacitor of the line, the smaller the harmonic frequency, the higher the POM harmonic voltage

$${V}_{WF}^{n} .$$

When fₙ→0 then

$${V}_{WF}^{n} \to ∞ .$$

On the other hand, the impact of the high-order or super-synchronous harmonics is relevantly insignificant according to Eq. (10).

Accordingly, when an IBR operates close to or beyond its PWM saturation boundary, more low- and high-order harmonics will be generated and injected into the transmission grid and when series capacitors are present in the transmission grid, low-order harmonics injected into the grid by IBRs and through the series compensated transmission lines will significantly increase the harmonic distortions. For a series compensated line, the low-order harmonic distortion of the wind turbine POC voltage caused by the series capacitor will pass through the low-pass filters, which will affect the PLLs and controllers of the wind turbine and therefore cause more harmonic currents injected into the grid. This will further increase the distortion of the POM and POC voltage caused by the series capacitor and therefore result in more harmonic currents injected by the wind turbines to the grid. With this iteration process continues, the harmonic distortion will continue to increase and the POM and POC voltage become more distorted, which will drive the wind turbines to oscillate more and more and eventually interrupt the operation of the wind turbines and/or the grid.

Systems and methods of the present disclosure may facilitate mitigating SSOs associated with a series compensated transmission grid. In some embodiments, SSOs can be mitigated via network-based mitigation. Additionally or alternatively, SSOs can be mitigated via generator-based mitigation.

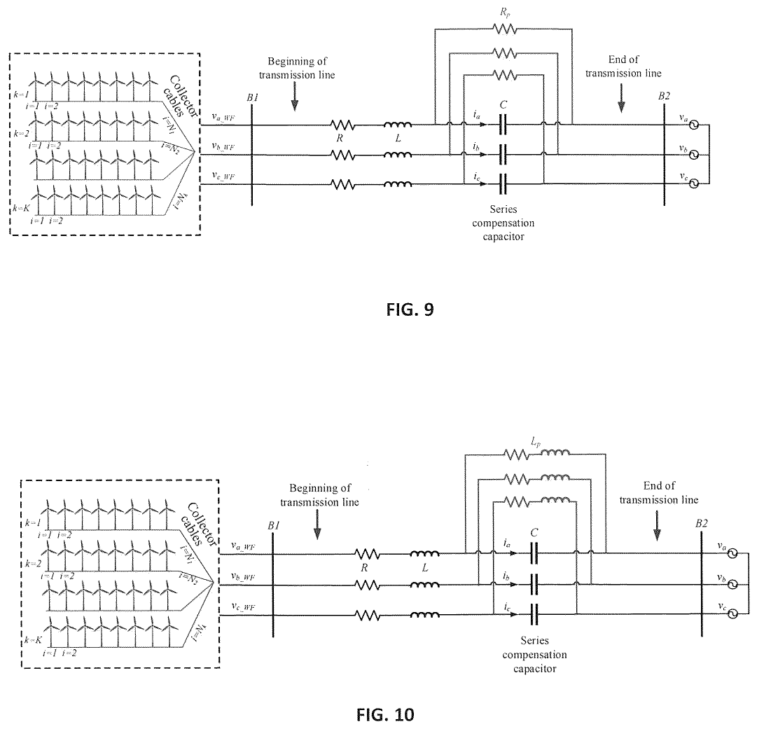

In various embodiments, a network-based mitigator mitigates SSO from the perspective of the electric utility. Mitigating SSO for series compensated transmission lines can be achieved by adding a resistor in parallel with the series capacitor (e.g., thereby avoiding low-order harmonics passing through the series capacitor) as shown in FIG. 9. Additionally or alternatively, SSO may be mitigated by adding an inductor in parallel with the series capacitor as shown in FIG. 10. These mitigation devices may be inexpensive. In various embodiments, the values of the resistor and/or inductor are determined based on (i) the added resistor or inductor should not affect the series capacitor compensation efficiency and performance at the fundamental frequency of the grid, (ii) the added resistor or inductor should not increase the resultant line resistance or resistive loss at the fundamental frequency of the grid, and/or (iii) the added resistor or inductor should not significantly increase the resultant line impedance below the fundamental frequency of the grid and should allow the low-order harmonic current to pass through the resistor or inductor although the series capacitor tries to block the low-order harmonic currents.

In various embodiments, the SSO mitigation device (e.g., a passive device electrically connected in parallel with a series capacitor of a transmission line) may reduce/remove POM voltage distortion. Additionally, IBR stability (including traditional electric generators) may be improved without affecting the series compensation effectiveness or increasing the loss of the power transmission. In various embodiments, the SSO mitigation device improves the efficiency of the series capacitor compensation. For example, instead of using a reduced degree of compensation, k in Eq. (1) can be 100% to achieve the full compensation of the transmission line inductance (e.g., thereby enhancing the transmission grid voltage stability and/or power transfer capability).

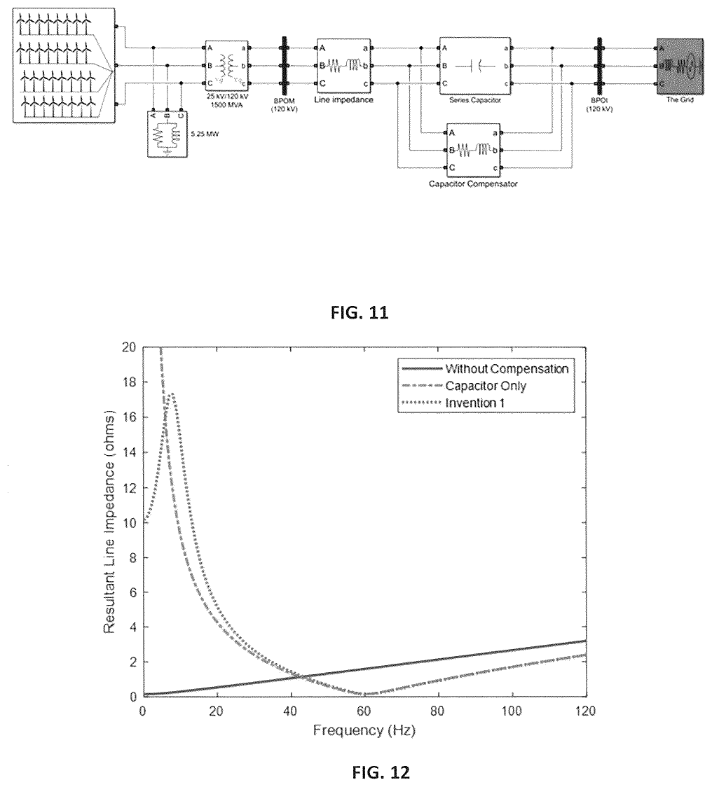

Referring now to FIG. 11, an example implementation of connecting an IBR plant to the grid through a series compensated transmission line with an inductor connected in parallel with the series capacitor is shown. As shown, the aggregated wind power plant model includes an IBR model connected to a 690V/25 kV step-up transformer via an LCL filter (e.g., which may be changed as an LC or L filter, etc.). The IBR unit has a renewable energy source (RES) on the left (such as a wind turbine or PV array) and a grid-connected inverter on the right. The RES controller controls the active power extracted from the RES and delivered to the grid based on a reference power command P*. The inverter controller controls the interconnection of the IBR with the grid. The IBR model, after its step-up transformer, is connected to the POM via an equivalent aggregated collector system model and a step-up transformer (25 kV/120 kV) of the IBR plant and then to the POI via the series compensated transmission line. The grid line-line voltage is, as an example, 120 kV RMS. Example parameters of the IBR plant model, transformers, and series compensated transmission line are shown in Table 1, below.

| | |
|---|---|
| IBR step-up transformer (690 V/25 kV) | R = 0.0048 Ω, |
| | L = 0.382 mH |
| Collector equivalent resistance (R_{CS}) | Variable |
| Collector equivalent inductance (L_{CS}) | Variable |
| Plant transformer (25 kV/120 kV) | 1500 MVA |
| power rating | |
| Plant transformer resistance and inductance | Rₜᵣₐₙₛ = 0.053 p.u., |
| | Lₜᵣₐₙₛ = 0.16 p.u. |
| Transmission line (120 kV) resistance (R_{TL}) | R_{TL} = 0.16 Ω |
| Transmission line (120 kV) inductance (L_{TL}) | L_{TL} = 4.233 mH |
| Series compensation capacitor | 1662 μF |
| Parallel inductor (Resistance & inductance) | R_{PL} = 10 Ω/L_{PL} = 212 mH |
| Grid Resistance at POI | R_{G} = 0.00348 Ω |
| Grid Inductance at POI | L_{G} = 0.254 mH |

At the grid fundamental frequency, the 120 kV transmission line inductive reactance is X_{TL}=ω·L=1.596Ω and the reactance of the series capacitor is X_{C}=1/(ω˜C)=1.596Ω (i.e., the degree of the compensation is 100%). Therefore, the compensated line impedance is 0.16Ω and is purely resistive at the fundamental frequency of the grid. With the added parallel inductor, the line resistance and reactance remain the same and the impedance of the combined series capacitor with the parallel inductor is Z_{CL}=(R_{PL}+jX_{PL})∥(−jX_{C}), which is 0.0041−j1.628Ω at the fundamental frequency of the grid. Hence, the compensated line impedance Z_{TL}+Z_{CL} is 0.1641−j0.032Ω at the grid frequency, which affects the series compensation effect just a little bit and still has the degree of the compensation close to 100%. In addition, only a very small increase in the line resistance, meaning that only a very small amount of extra loss is introduced by the parallel inductor.

FIG. 12 shows a comparison of the transmission line impedance amplitude vs the frequency without the series compensated capacitor, with the series capacitor, and with both the series capacitor, and with a parallel inductor plus a resistor (e.g., as shown in the table above). In various embodiments, without the series compensated capacitor, the line impedance increases as the frequency increases. With the series capacitor, the compensated line impedance above the fundamental frequency increases as the frequency increases and is smaller than the line impedance without the compensation, showing the effectiveness of the series compensation. However, the compensated line impedance below the fundamental frequency increases as the frequency decreases and reaches infinity at the DC condition (e.g., which may cause SSO).

With both the series capacitor and a parallel inductor plus a resistor, the compensated line impedance above the fundamental frequency is approximately the same for the frequency above the fundamental frequency. However, below the fundamental frequency, the line impedance may be reduced. Therefore, with a parallel inductor/resistor, the series compensation efficiency is maintained but the SSO is effectively mitigated.

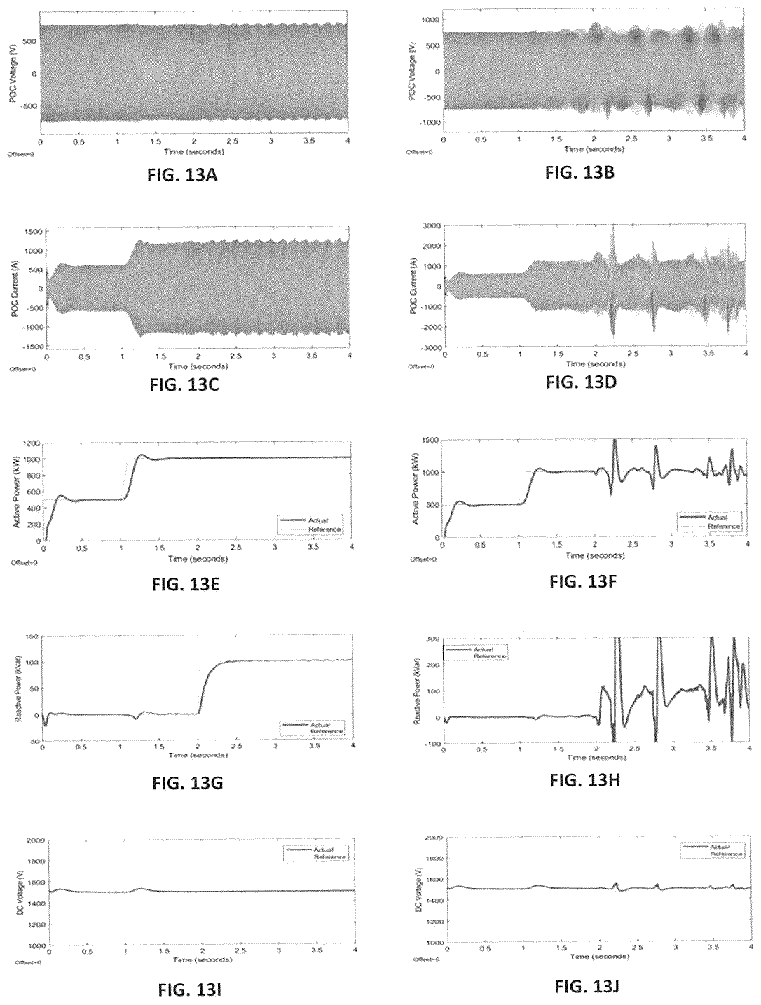

Turning now to FIGS. 13A-13J, EMT simulation results of the IBR plant connected to the grid via the series compensated line without and with the SSO mitigation device (e.g., a passive device electrically connected in parallel with a series capacitor) are shown. The plant includes 600 IBR units with a power rating of 1.5 MW for each IBR unit. The active power reference of each IBR unit is 500 kW before 1 sec and change to 1000 kW at 1 sec. The reactive power reference of each IBR unit is 0 k Var before 2 sec and change to 100 k Var after 2 sec.

Without using the SSO mitigation device, the SSO effect starts to develop when the IBR active power reference increases from 500 kW to 1000 kW at 1 sec (FIG. 13B). The SSO and the POC voltage distortion becomes worse after the reactive power reference increases from 0 k Var to 100 k Var at 2 sec. With the increased POC voltage distortion, more harmonics are generated by IBRs and high current oscillations are present (FIG. 13D), which can cause the IBR to be tripped and disconnected from the grid. The SSO effects are also present in the active and reactive powers injected by an IBR to the grid (FIG. 13F and FIG. 13H) as well as the DC link voltage of an IBR (FIG. 13J).

With the SSO mitigation device, the SSO effect is effectively mitigated as shown in FIG. 13A, 13C, 13E, 13G and FIG. 13I. The IBRs within the plant can properly and safely deliver the maximum active and reactive power to the grid through the series compensation capacitor and the SSO and POC harmonic distortions are not amplified. The reliable power transmission through the series compensated transmission line is ensured and the voltage stability and power transfer capacity are increased because the full compensation capacity of the series compensation is enabled by using the example implementation one.

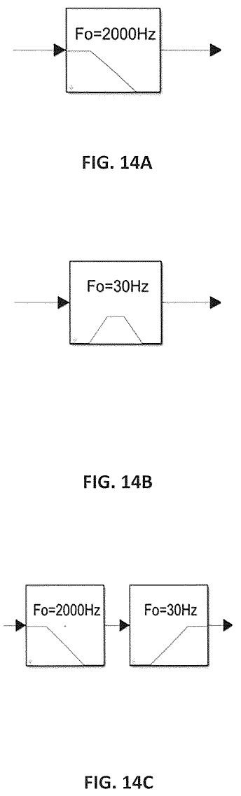

In some embodiments, SSO mitigation is achieved from a perspective of a generator, wind, solar, STATCOM, HVDC, and/or charging station. For example, an SSO mitigation device may include a band-pass filter (e.g., in place of a low-pass filter shown in FIG. 14A) or a high-pass filter (e.g., after a low-pass filter, etc.) as shown in FIG. 14B and FIG. 14C. In various embodiments, low-pass filters can only remove the high-frequency distortion impact (e.g., such as the high-frequency distortion of the wind turbine POC voltage, etc.). In various embodiments, with a series capacitor on the transmission line, the capacitor can generate sub-synchronous harmonic distortion on the POM or POC voltage of a wind turbine or an IBR (e.g., thereby negatively impacting the operation of the wind turbine or IBR and causing more feedback harmonics).

In various embodiments, the SSO mitigation device (e.g., a band-pass filter or a combination of a low-pass filter and a high-pass filter) is designed to remove the high-frequency harmonic distortion impact and remove the low-frequency harmonic distortion impact. In various embodiments, the SSO mitigation device prevents the sub-synchronous harmonic voltage distortion caused by the series capacitor from entering the controllers of an IBR or a generator. In various embodiments, by eliminating the high-order harmonic voltage distortion (e.g., caused by the line inductor), the low-order harmonic voltage distortion (e.g., caused by the series capacitor) is reduced/eliminated. In various embodiments, the band-pass, low-pass, and/or high-pass filters are analog filters applied after the sensor devices. In various embodiments, this SSO mitigation device is inexpensive.

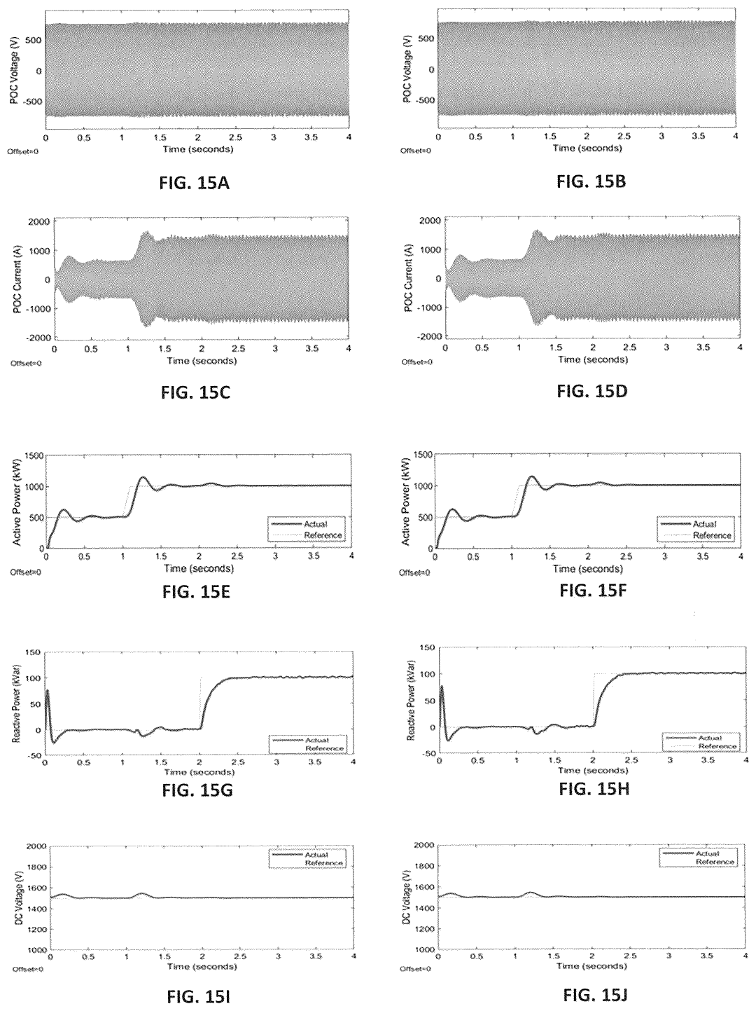

Turning now to FIGS. 15A-15J, various EMT simulation examples are shown to demonstrate the performance of the SSO mitigation device. The EMT simulation model may be similar to FIG. 11 (e.g., with the exception that a low-pass filter plus a high-pass filter is applied to the measured three-phase POC voltage signals of each IBR unit that needs to be sent to IBR controllers and its PLL). In various embodiments, the low-pass filter has a cutoff frequency of 1000 Hz and the high-pass filter has a cutoff frequency of 30 Hz. In these examples the IBR plant is connected to the grid through the transmission line with the series compensation capacitor. In FIGS. 15A, 15C, 15E, 15G and 15I, the series capacitor is connected in the transmission grid without the parallel inductor. In FIGS. 15B, 15D, 15F, 15H and 15J, the series capacitor is connected in the transmission grid with the parallel inductor.

In various embodiments, the SSO mitigation device effectively eliminates the low-frequency harmonic distortion from getting into the IBR controller and its PLL, which terminates the iterative harmonic amplification (feedback). As a result, the harmonic impacts are mitigated, which assures the stable and reliable operation of the IBRs and the grid.

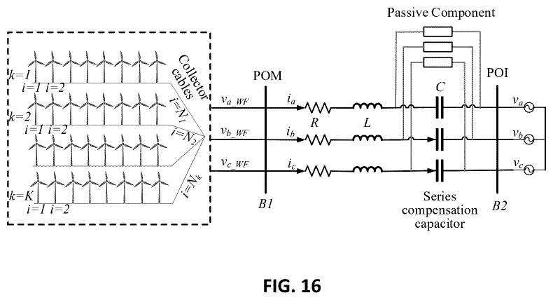

In various embodiments, SSO mitigation passive components are designed such that (i) the added passive component does not affect the series capacitor compensation efficiency and performance at the fundamental frequency of the grid, (ii) the added passive component does not increase the resultant resistance or resistive loss of the series compensated transmission line at the fundamental frequency of the grid, and/or (iii) the added passive component does not significantly increase the resultant impedance of the transmission line below the fundamental frequency of the grid and allows the low-order harmonic current to pass through the passive component although the series capacitor tries to block the low-order harmonic currents. SSO mitigation may include adding a passive component in parallel with a series compensation capacitor of a transmission line of a grid, as shown in FIG. 16.

In various embodiments, the passive component is and/or includes a resistor (e.g., SSO mitigation is achieved via a resistor in parallel with the compensation capacitor). For example, a resistor may be added in parallel to the series capacitor of a transmission line. The resistance value can be low to high.

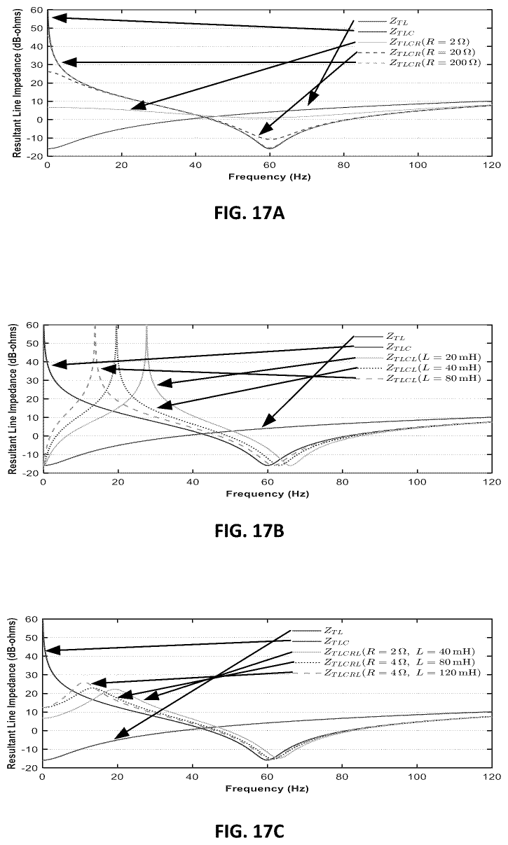

Referring now generally to FIGS. 17A-17C, several examples of frequency characteristics of a series compensated transmission line with different SSO mitigation passive devices are shown. As a first example, a resistor in parallel with the series compensation capacitor is discussed. Example parameters of the transmission line with the series compensation capacitor are shown in the table below this paragraph. As an example, at the grid fundamental frequency, the inductive reactance of a 120 kV transmission line is X_{TL}=ω·L=1.596Ω and the reactance of the series capacitor is X_{C}=1/(ω·C)=1.596Ω. The degree of the compensation of the transmission line may be 100% according to this example. Still referring to this example, the impedance of the compensated line is Z_{TLC}=Z_{TL}−j X_{C}=R_{TL}=0.16Ω and is purely resistive at the fundamental frequency of the grid. With an added parallel resistor R_{P}, the impedance of the combined series capacitor with the parallel resistor is Z_{CR}=R_{P}∥(−jX_{C}) and the impedance of the compensated line is Z_{TLCR}=Z_{TL}+Z_{CR}.

| | |
|---|---|
| Rated line-to-line voltage | 120 kV |
| Transmission line resistance (R_{TL}) | R_{TL} = 0.16 Ω |
| Transmission line inductance (L_{TL}) | L_{TL} = 4.233 mH |
| Series compensation capacitor | 1662 μF |

The table below this paragraph shows Z_{CR} and Z_{TLCR} at the grid frequency for three parallel resistance values, i.e., small, medium, and large, according to several examples. According to this example, the smaller R_{P} is, the more Z_{CR} is different from X_{C}, which reduces efficiency of the series capacitor compensation at the fundamental grid frequency. In addition, the resistive part of Z_{CR} increases as R_{P} decreases, meaning that a small R_{P} causes high loss of the series compensation. On the other hand, the larger R_{P} is, the less Z_{CR} is different from X_{C} and the smaller the resistive part of Z_{CR} is, which ensures the series capacitor compensation efficiency at the grid frequency with a low additional loss introduced by the parallel resistor.

| R_{P} (Ω) | Z_{CR} (Ω) | Z_{TLCR} (Ω) |
|---|---|---|
| 2 | 0.778 − j0.975 | 0.938 + j0.621 |
| 20 | 0.127 − j1.586 | 0.287 + j0.01 |
| 200 | 0.013 − j1.596 | 0.173 |

Referring specifically to FIG. 17A, the frequency characteristics of the example transmission line (i) without the series compensation, (ii) with the series capacitor compensation only, and (iii) with series compensation capacitor in parallel with resistors listed in the table above this paragraph are shown. The y-axis is dB-ohms (e.g., which represents the line impedance amplitude computed as 20·log₁₀(|Z|)). As shown in this example, (i) the series compensation capacitor may introduce a high impedance at low frequencies and may reach infinity at DC (e.g., thereby increasing the potential development of SSR/SSO), (ii) a low parallel resistor may not introduce a high impedance at low frequencies and DC but may reduce the series capacitor compensation efficiency, may increase transmission line resistance, and may introduce a line loss at the grid frequency, and (iii) a high parallel resistance may ensure the series compensation efficiency and may introduce very small additional loss to the transmission line at the grid frequency while also presenting a high impedance at low frequencies.

As a second example, an inductor in parallel with the series compensation capacitor is discussed. The inductance values (low, medium, and high) are shown in the table following this paragraph. According to this example, with an added parallel inductor L_{P}, the impedance of the combined series capacitor and the inductor is Z_{CL}=jX_{P}∥(−jX_{C}), where X_{P}=ω·L_{P}. The compensated line impedance is Z_{TLCL}=Z_{TL}+Z_{CL}. The table above paragraph shows Z_{CL} and Z_{TLCL} at the grid frequency for three parallel inductance values. Referring specifically to FIG. 17B, the frequency characteristics of the transmission line are shown for the line (i) without the series compensation, (ii) with the series capacitor compensation only, and (iii) with a series compensation capacitor in parallel with inductors listed in the table below this paragraph.

| L_{P} (mH) | Z_{CL} (Ω) | Z_{TLCL} (Ω) |
|---|---|---|
| 20 | −j2.024 | 0.16 − j0.428 |
| 40 | −j1.785 | 0.16 − j0.189 |
| 80 | −j1.685 | 0.16 − j0.089 |

As shown in this example, (i) a large L_{P} value may be more efficient than small L_{P} value (e.g., due to the impact on capacitor compensation efficiency, etc.), (ii) unlike the parallel resistor, the parallel inductor does not introduce additional loss to the compensated transmission line, which may be advantageous, and (iii) a parallel inductor may bypass the DC current and mitigate the SSR/SSO around DC frequency while resulting in a new SSR/SSO occurrence around another subsynchronous frequency.

As a third example, a series combination of a resistor and an inductor is discussed. Several example resistance and inductance values of the parallel RL are shown in the table below this paragraph. According to this example, in a series combination of R_{P} and L_{P} in parallel with the capacitor, the impedance of the combined series capacitor with the parallel RL is Z_{CRL}=(R_{P}+jX_{P})∥(−jX_{C}). The compensated line impedance is Z_{TLCRL}=Z_{TL}+Z_{CRL}. The table following this paragraph shows Z_{CRL} and Z_{TLCRL} at the grid frequency for three parallel RL conditions. FIG. 17C illustrates frequency characteristics of the transmission line (i) without the series compensation, (ii) with the series capacitor compensation only, and (iii) with series compensation capacitor in parallel with RLs listed in the table following this paragraph.

| R_{P} (Ω) | L_{P} (mH) | Z_{CRL} (Ω) | Z_{TLCRL} (Ω) |
|---|---|---|---|
| 2 | 40 | 0.027 − j1.781 | 0.187 − j0.185 |
| 4 | 80 | 0.012 − j1.683 | 0.172 − j0.087 |
| 4 | 120 | 0.005 − j0.057 | 0.165 − j0.058 |

According to this example, (i) by selecting R_{P} and L_{P} values, the series capacitor compensation efficiency can be maintained while the extra loss introduced by the parallel RL is trivial at the grid frequency and (ii) the addition of a resistor R_{P} in series with the inductor L_{P}, the resonance between the series capacitor and the parallel inductor may be greatly constrained, which may prevent the occurrence of a new SSR/SSO caused by the resonance of capacitor and parallel inductor.

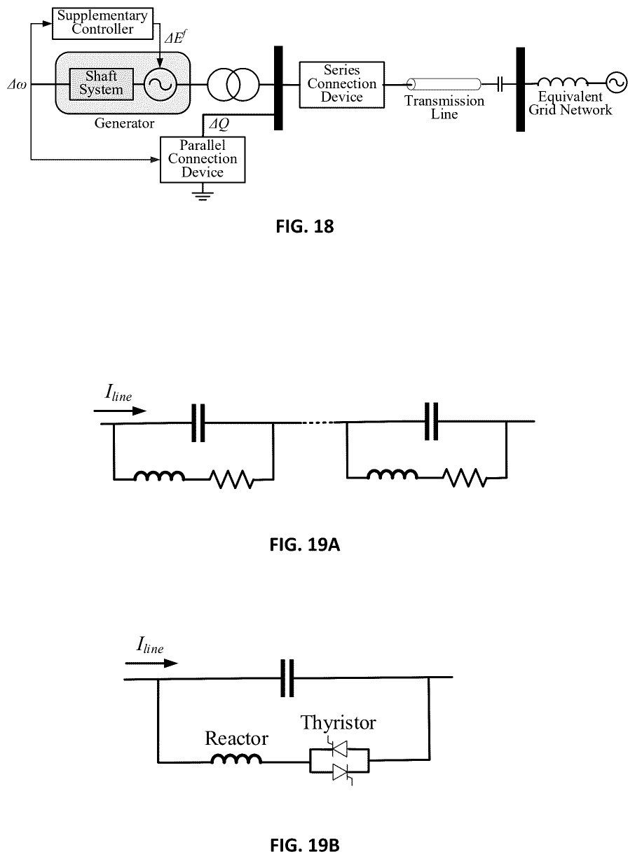

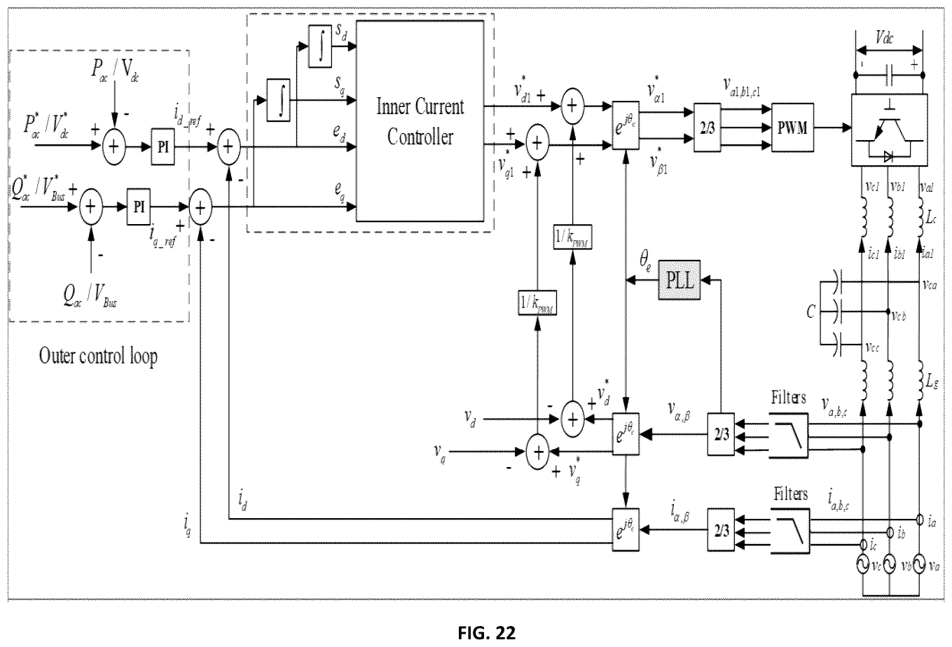

Referring now to FIGS. 18-23, generator-based systems/apparatuses/methods for mitigating SSR/SSO are discussed. As shown, in FIG. 18, SSO mitigation may include (i) series-connected devices, (ii) parallel-connected devices, and/or (iii) supplemental control systems installed at the generator or its POC.

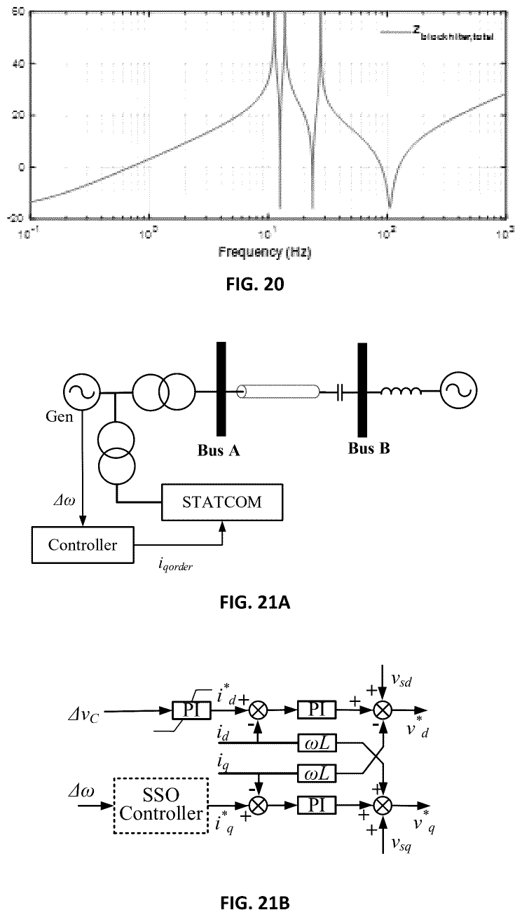

A series-connected device may be installed between the generator and a series-compensated transmission line to shield the generator from SSR/SSO phenomena occurring at specific subsynchronous frequencies. Series-connected devices may operate by forming a high-impedance parallel resonance at the electrical frequency related to the critical SSR/SSO mode. This high impedance may block subsynchronous currents from flowing into the generator. In some embodiments, the blocking capability is extended over a wider subsynchronous frequency range using multiple blocked filters (shown in FIG. 19A) or a thyristor-controlled blocked filter (shown in FIG. 19B). FIG. 20 illustrates an example frequency response of a series connection device having multiple blocked filters.

In some contexts, subsynchronous harmonic currents originate from the generators themselves (e.g., such as in wind or solar generators operating near their PWM saturation limits). In these cases, block filters may block the outward flow of subsynchronous harmonic currents from the generators (which may lead to significant voltage distortion at the generator's POC or POM, which may induce the generation of additional harmonic currents from the generators). In some embodiments, block filters may exacerbate SSR/SSO conditions in series-compensated transmission systems.

In some embodiments, parallel-connected devices include a static var compensator (SVC) and/or a static synchronous compensator (STATCOM). A STATCOM may be connected at the generator terminal bus or on the high-voltage side of the generator step-up transformer, as illustrated in FIG. 21A. In various embodiments, a STATCOM is operated as a controlled current source with two degrees of freedom (shown in FIG. 21B). In such embodiments, the d-axis current is regulated to maintain the DC-link capacitor voltage at its rated level, while the q-axis current is used to control the voltage at the connection point. In various embodiments, since the STATCOM is installed close to the generator, its voltage regulation may influence the electromagnetic power or torque of the generator. In some embodiments, a STATCOM may be ineffective at suppressing subsynchronous harmonic interactions between the generator and series-compensated transmission lines (and therefore may be unable to mitigate SSR/SSO phenomena in systems using series capacitor compensation).

In some embodiments, SSO mitigation may include the application of supplementary control to the generator's excitation system to mitigate SSR. For example, supplementary controllers may use shaft speed deviation (Δω) as the input signal and may apply amplification and phase compensation to produce an incremental change in excitation voltage (e.g., as shown in FIG. 18).

In various embodiments, supplementary control methods may not be usable with some exciter types (e.g., due to their dependence on the exciter's time constant). For example, rotating exciters may possess time constants that are too large to respond effectively to sub-synchronous frequency signals

As discussed, in a transmission line without series compensation capacitors, low-order harmonic currents flowing through the line may not amplify or worsen voltage distortion at the POM bus (e.g., because the lines are primarily inductive and present very low impedance to low-order harmonic currents, etc.). In some contexts, low-pass filters are used to reduce/eliminate high-frequency harmonics in measured signals from entering inverter-based resource (IBR) or generator controllers. As shown in FIG. 21, filters may be applied to individual measured signals before they reach the controller input. In various embodiments, low-pass filters are not capable of addressing issues related to low-order harmonic distortion. In various embodiments, the presence of series compensation capacitors changes this dynamic. For example, when low-order harmonic currents from a generator attempt to pass through these capacitors, the high impedance of the capacitors at low frequencies can result in significant voltage distortion at the POM bus. This distortion can interfere with the operation of IBRs or generators, potentially triggering further harmonic generation.

Systems and methods of the present disclosure may reduce/eliminate SSR and SSO by interrupting the iterative amplification loop of harmonic distortion between the generator and the transmission grid. For example, the SSO mitigation method of the present disclosure may (i) prevent high-frequency noise and harmonic distortion originating from the transmission grid from being amplified within the generator (high-order distortions may arise from high-frequency harmonic currents interacting with the inductive elements of the transmission network), (ii) prevent subsynchronous distortions from propagating/growing, and/or (iii) may maintain stable control at the grid's fundamental frequency (e.g., thereby ensuring reliable power conversion and system stability under varying harmonic conditions).

In various embodiments, systems and methods of the present disclosure achieve SSO mitigation by (i) passing each measured signal through a low-pass filter before it is fed into the generator controller, (ii) applying a high-pass filter to each measured signal to prevent low-frequency disturbances from entering the generator controller, and (iii) correcting for any phase lag and amplitude attenuation cause by the low- and high-pass filters using a compensation circuit. In various embodiments, the low-pass filter is designed to eliminate high-frequency noise, switching transients from power electronic converters, and high-order harmonic distortions. In various embodiments, the filter's cutoff frequency is one to two orders of magnitude lower than the converter's switching frequency, while remaining higher than the control bandwidth. In various embodiments, a cutoff frequency of the high-pass filter approximately half the grid's fundamental frequency (e.g., 30 Hz for a 60 Hz system), thereby attenuating sub-synchronous content while preserving the integrity of the fundamental signal.

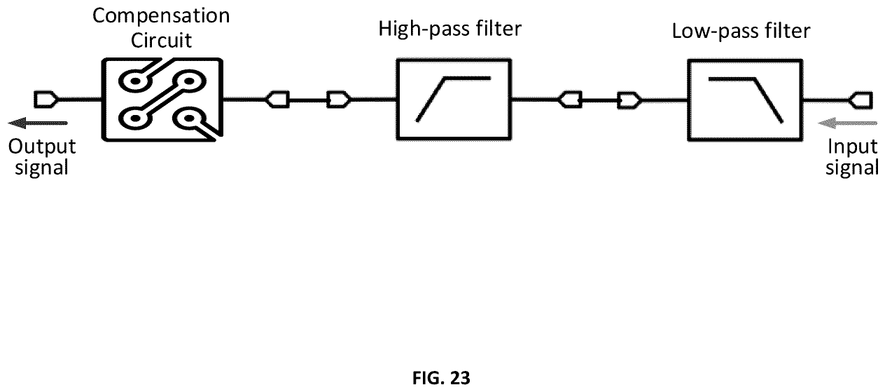

FIG. 23 illustrates a combined filtering apparatus including a low-pass, a high-pass, and a compensation circuit. In various embodiments, the combined filtering apparatus is applied to each measured signal. The combined filtering apparatus may be designed to: (i) eliminate high-order voltage distortion introduced by the inductive elements of the transmission line; (ii) suppress low-order harmonic voltage distortion resulting from the presence of series capacitors; and (iii) correct for phase shifts and amplitude attenuation at the grid's fundamental frequency introduced by the filtering stages. In various embodiments, the combined filtering apparatus is implemented on the low-voltage side (e.g., after the potential transformer (PT) and current transformer (CT)), thereby making it cost-effective.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

What is claimed is:

1. An apparatus for mitigating sub-synchronous oscillation (SSO) in a transmission line having a series capacitor compensations system, comprising:
a passive component connected in parallel with the series capacitor compensation system on the transmission line, wherein the passive component is configured to pass low-order harmonic currents.

2. The apparatus of claim 1, wherein the passive component comprises at least one of (i) a resistor, (ii) an inductor, or (iii) a series combination of the resistor and the inductor.

3. The apparatus of claim 2, wherein the passive component comprises the series combination of the resistor and the inductor.

4. The apparatus of claim 3, wherein the transmission line is part of a grid, wherein the grid is an interconnected network for electricity delivery from producers to consumers.

5. The apparatus of claim 4, wherein the resistor does not affect an efficiency of the series compensation capacitor at a fundamental frequency of the grid.

6. The apparatus of claim 4, wherein the resistor does not increase a resultant line resistance or resistive loss at a fundamental frequency of the grid.

7. The apparatus of claim 4, wherein the resistor does not increase a resultant line impedance below a fundamental frequency of the grid and allows low-order harmonic current to pass through the resistor, and wherein the series compensation capacitor blocks the low-order harmonic current.

8. The apparatus of claim 4, further connected to an electric generator.

9. The apparatus of claim 4, wherein the passive component reduces an increase in low-order bus voltage distortion in the transmission line.

10. A method of mitigating sub-synchronous oscillation (SSO) in a transmission line having a series capacitor compensation system, comprising:
coupling, to the transmission line and in parallel with the series capacitor compensation system, a series combination of a resistor and an inductor.

11. The method of claim 10, wherein the series combination of the resistor and the inductor reduce an increase in low-order bus voltage distortion in the transmission line.

12. The method of claim 11, further comprising determining an inductance of the inductor and a resistance of the resistor that together allow low-order harmonic current to pass through the resistor.

13. The method of claim 12, wherein the transmission line is connected to a grid, and wherein determining the inductance and the resistance comprises determining the inductance and the resistance based on a capacitance of the series capacitor compensation system and one or more parameters of the grid.

14. An electric generator system, comprising:
an electric generator;
a generator controller, wherein the electric generator is electrically connected to the generator controller via an electrical conductor;
a signal conditioning system disposed on the electrical conductor and configured to filter signals traveling from the electrical generator to the generator controller.

15. The electrical generator system of claim 14, wherein the signal conditioning system comprises at least one of (i) a band-pass filter, (ii) a low-pass filter, (iii) a high-pass filter, or (iv) a compensation circuit, and wherein the electric generator comprises at least one of (a) a synchronous generator, (b) an induction generator, (c) a wind turbine, (d) a solar photovoltaic generator, (e) an electric vehicle charging device, (f) a high-voltage direct current (HVDC) transmission system, (g) a static synchronous compensator (STATCOM), or (h) an inverter-based data center.

16. The electrical generator system of claim 15, wherein the signal conditioning system prevents high-frequency noise and harmonic distortion originating from a transmission grid from being amplified within the electric generator.

17. The electric generator system of claim 15, wherein the signal conditioning system prevents sub-synchronous-frequency distortion originating from a transmission grid from being amplified within the electric generator.

18. The electric generator system of claim 15, wherein the signal conditioning system maintains a frequency of measured signals at a fundamental frequency of a grid, wherein the grid is an interconnected network for electricity delivery from producers to consumers.

19. The electric generator system of claim 14, further comprising a sensor, and wherein the signal conditioning system is applied after the sensor to prevent low-order harmonics and high-order harmonics from entering the generator controller, and wherein the signal conditioning system has a low cut-off frequency below a fundamental frequency of a grid that the electrical generator system is connected to and a high cut-off frequency above a fundamental frequency of a grid.

20. The electric generator system of claim 19, wherein the low cut-off frequency is between 20 Hz and 30 Hz and the high cut-off frequency is between 1000 Hz and 3000 Hz.
